(19) United States
(12) Patent Application Publication
(10) Pub. No.: US 2024/0387881 A1
(43) Pub. Date: Nov. 21, 2024

(54) AUTOMATED FLOODED LEAD-ACID BATTERY MAINTENANCE

(71) Applicant: Saudi Arabian Oil Company, Dhahran (SA)

(72) Inventors: Tariq Alateeq, Dhahran (SA); Abdullah Alnufaii, Dhahran (SA); Yousif Alghamdi, Dhahran (SA)

(21) Appl. No.: 18/319,236

(22) Filed: May 17, 2023

(51) Int. Cl. H01M 10/12; H01M 10/48; H01M 50/609; H01M 50/682

(52) U.S. Cl. CPC H01M 10/12; H01M 10/484; H01M 50/609; H01M 50/682

(57) ABSTRACT

A system and a method for automatically maintaining a flooded lead-acid battery are provided. An exemplary method includes producing distilled water from air condensation, monitoring an electrolyte level in the flooded lead-acid battery, and adding the distilled water to the flooded lead-acid battery to maintain the electrolyte level.

### TECHNICAL FIELD

This disclosure relates to methods of an automated system for maintaining flooded lead-acid batteries.

### BACKGROUND

Many off grid solar systems are used installations in remote locations, for example, for instrument control and communications. While numerous battery types can be used to provide continuous operation during dark hours, flooded lead-acid batteries provide a deep cycle and the lowest cost per amp power and kilowatt-hour. However, the liquid electrolyte in flooded lead-acid batteries is often partially electrolyzed during charging, forming hydrogen and oxygen gas, which are released from the battery.

As a result, the liquid level in the flooded lead-acid batteries drops during every charging cycle. Over time, low battery levels will lead to the formation of lead sulfate crystals on the electrode panels, termed sulfation, which will cause the battery to fail. To maintain flooded lead-acid batteries, water must be added on a regular basis to keep the electrolyte levels high enough to prevent concentration of the electrolyte and the deposition of the lead sulfate crystals on the lead panels. Unfortunately, the need for regular maintenance by the addition of water makes the use of flooded lead-acid batteries problematic in remote installations, such as unmanned offshore platforms. In these types of environments, operators may not be able to visit the site for months due to weather constrains. In addition to the necessity to travel to the remote location, transportation of distilled water to the location adds to the cost and difficulties.

### SUMMARY

Embodiments described herein provide a system for maintaining a flooded lead-acid battery. The system includes a flooded lead-acid battery, a condenser to condense water from humid air, and a water tank to store the condensed water. A water pump is fluidically coupled between the water tank and the flooded lead-acid battery through a water line, wherein, when activated, the water pump fills the flooded lead-acid battery from the water tank through the water line. The flooded lead-acid battery includes a level sensor to measure the level of electrolyte in the flooded lead-acid battery and a controller, wherein the controller is coupled to the level sensor and the water pump. The controller includes a processor and instructions that direct the processor to monitor the level of electrolyte in the flooded lead-acid battery and activate the water pump if the level of electrolyte is lower than a target value.

Another embodiment described herein provides a method of automatically maintaining a flooded lead-acid battery. The method includes producing distilled water from air condensation, monitoring an electrolyte level in the flooded lead-acid battery, and adding the distilled water to the flooded lead-acid battery to maintain the electrolyte level.

### BRIEF DESCRIPTION OF DRAWINGS

FIG. 1 is a block diagram of a remote maintenance system for maintaining lead acid batteries.

FIG. 2 is a method of remotely maintaining lead acid batteries using a remote maintenance system.

FIG. 3 is a block diagram of a controller for the remote maintenance system.

### DETAILED DESCRIPTION

Embodiments described herein provide a system that automates preventive maintenance for flooded lead-acid batteries. Flooded lead-acid batteries, one of the most cost-effective batteries for grid storage, require regular maintenance procedures. Although most maintenance procedures can be done remotely, two procedures currently cannot be done remotely, the addition of distilled water and visual inspection of the flooded lead-acid batteries.

Adding distilled water is required periodically, for example, whenever there is a discharge and charge cycle. If water is not added to the batteries, especially after charging, this may lead to permanent damage of the batteries. The chemical reaction equation for the discharging of flooded lead-acid batteries is:

Pb+PbO₂+2H₂SO4→2PbSO₄+2H₂O

The SO₄²⁻ ion reacts with the lead (Pb) during discharging. Initially, the PbSO₄ formed is amorphous, but over time if will form crystalline solids on the Pb electrodes which would make the reaction difficult, if not impossible, to reverse. The chemical reaction equation for the charging of flooded lead-acid batteries is:

2PbSO₄+2H₂O→Pb+PbO₂+2H₂SO₄

Thus, charging needs to be performed as soon as possible after discharge. Moreover, during charging of the batteries the charging current will ionize water to 2H⁺ and O²⁻, the 2H⁺ will react with SO₄²⁻ at one plate making it return to its initial form as H₂SO₄. However, the electrical current usually ionizes water at a faster rate than the charging reaction could take place, leading to electrolysis. The electrolysis generates gases that escape the battery jar. If water cannot be added to the battery in a timely manner, permanent damage to the battery cells may occur, for example, through the formation of PbSO₄ crystals on the lead plates, i.e., sulfation.

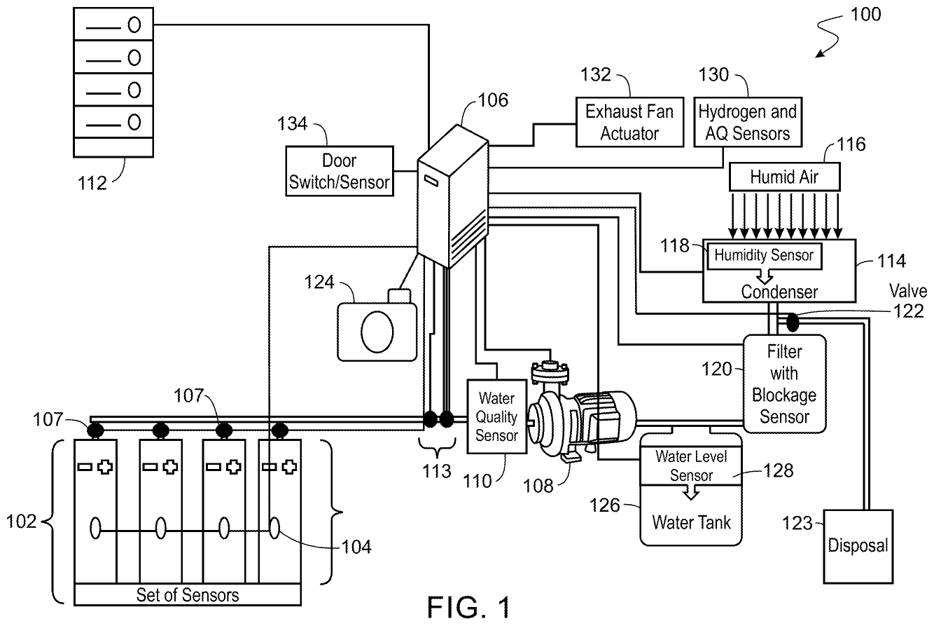

FIG. 1 is a block diagram of a remote maintenance system 100 for maintaining flooded lead-acid batteries 102. In various embodiments, the flooded lead-acid batteries 102 have level sensors 104 that are used to detect the electrolyte levels. The data from the level sensors 104 is provided to a controller 106. Based on the data, the controller 106 can determine that water should be added to one or more of the flooded lead-acid batteries 102, for example, by opening valves 107 on the flooded lead-acid batteries 102 and activating a pump 108. The valves 107 the batteries are one-way valves to help prevent acid from being released from the batteries.

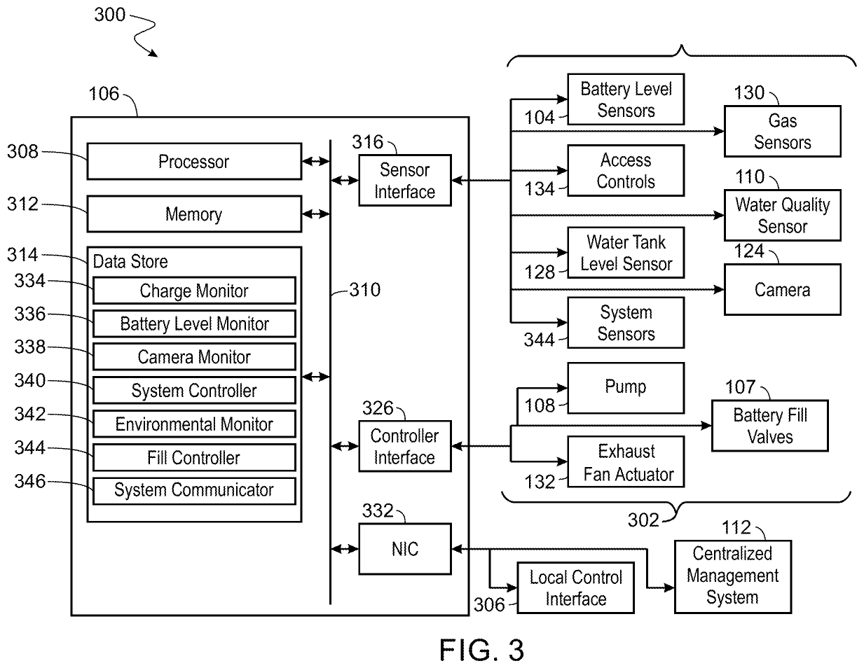

A water quality sensor 110 is used to measure whether the quality of the water is sufficient for addition to the flooded lead-acid batteries 102. For example, in various embodiments, the water quality sensor 110 is used to measure pH, total dissolved solids, electrical conductivity, salinity, temperature, surrogate and solid particles concentration (ppm), and the like. If the water quality sensor 110 indicates that the water quality is not sufficient for use, the controller 106 will provide a signal to a centralized management system 112, for example, through a network interface card (NIC) as discussed further with respect to FIG. 3. Further, the controller 106 can shut valves 113 to prevent poor quality water from being added to the flooded lead-acid batteries 102

The centralized management system 112 may not be located proximate to the remote maintenance system 100, but may be a corporate network, a remote control system, or a remote computer at an operations station. In some embodiment, the link to the remote maintenance system 100 may be through a satellite uplink, a radio uplink, or a fiber optic cable coupled to a driver connected to the NIC.

As the relative humidity is often high in the remote sites, such as offshore installations, the water for the system can be generated by a condenser 114 from humid air 116. The condenser 114 can be either passive or active condenser. A humidity sensor 118 can report the relative humidity of the air to the controller 106, allowing the controller 106 to determine whether the cooling for the condenser 114 is sufficient to condense moisture from the humid air 116. For example, the relative humidity may be higher at night, making it more practical to activate the condenser 114.

The water from the condenser 114 is passed through a filter 120 purify the water, for example, capturing any biological particles formed in the condenser 114. A blockage sensor informs the controller 106 if the filter is not passing a sufficient flow of water to prevent backup. If the filter 120 is blocked, the controller 106 may open a disposal valve 122 to send the excess water to disposal 123. For offshore applications, the disposal 123 may be a simple drain leading to the ocean.

The water from the condenser 114 is stored for use in a water tank 126, allowing the condenser 114 to be run intermittently, for example, during periods of high relative humidity. A level sensor 128 allows the controller 106 to monitor the level in the water tank 126. If the level drops too low, for example, due to a partially blocked filter 120, the controller 106 will alert an operator by sending a signal to the centralized management system 112.

In some embodiments, the pump 108 is reversible. If analytics in the controller 106 determine from the data from the humidity sensor 118, filter blockage sensor, and level sensor 128 indicate that the filter 120 is partially or fully blocked the controller 106 will reverse the pump 108 to backwash and clean the filter 120. This is performed by pumping water from the water tank 126 in the opposite direction and discarding the debris to the disposal 123. The controller 106 may be programmed to backwash the filter 120 at regular intervals or conditions, such as when the water tank 126 reaches a certain threshold, for example, 95% full.

In some embodiments, the controller 106 is linked to a camera 124 to monitor the flooded lead-acid batteries 102. An artificial intelligence (AI) visual analysis may determine if problems are present. Such AI visual analysis systems are commercially available, for example, from SAS, Meta, or any number of other sources. In an embodiment, The AI visual analysis systems is the Watson Visual Recognition system from IBM, which uses deep learning algorithms to analyze images to find certain scenes, such as cracking, corrosion, or sulfation, among others.

In various embodiments, the AI visual analysis system is used to detect corrosion or other visual defects, such as sulfation, cracks, leakage, and plate growth. When an issue is detected, the controller 106 will alert an operator, and identify the location of the defect, such as in a specific cell or battery. If possible, the controller 106 will take corrective measure if possible. For example, if the camera detects corrosion though visual recognition, the controller 106 will give a signal to the rectifier to reduce the voltage, or take a cell off line. If sulfation is detected, it will give a command to increase the voltage to a cell.

In various embodiments, the controller 106 is also linked to a number of environmental sensors and actuators. These include gas sensors 130, such as hydrogen gas sensors and acid gas sensors. Other sensors include access controls 134 to detect whether a door to the battery room is open. The access controls 134 may also include door switches for the controller 106 to lock the door if the gas sensors 130 determine if the concentration of acid gases or hydrogen is high. The access controls 134 may be used for access management and entry alarms.

In some embodiments, if hydrogen or acid gas concentration is above a setpoint the controller 106 will activate an exhaust fan actuator 132 to start or increase the speed of a fan. If the speed is at a maximum and the level of gases is still high, the controller will reduce charging current to reduce the amount of hydrogen produced. It is worth to mention that water filling is needed during discharge/charge operation.

The controller 106 can be integrated with other battery management features like cell voltage measurement, current, specific of gravity, inter cell resistance, interties resistance measurements, and electrolyte level, among others. This can be The smart controller will give alarm to the dispatch center for any alarm and/or will provide corrective action if necessary like voltage on boost or voltage balance on cells or fill the battery jar with distilled water when necessary. In addition, the system can have different configurations based on the end user requirements.

The remote maintenance system 100 is not limited to the devices above. For example, the system is scalable to allow an increase in the number of flooded lead-acid batteries 102. Additional cameras may be added to monitor larger systems, e.g., including more flooded lead-acid batteries. Further, the remote maintenance system 100 may interface with a fire alarm system, and if the visual analysis of the images collected by the camera 124 identifies a fire, a fire system may be activated. The fire system may include, for example, electrical cutoffs, automatic foam deployment, and remote monitoring capabilities to provide images to the operator at the centralized management system 112. The controller may also be interfaced with an HVAC (heating ventilation and air conditioning) system to provide monitoring and control over the HVAC system.

Further, the remote maintenance system 100 may be simplified by removing some of the devices discussed above. For example, a simpler configuration of the remote maintenance system 100 may remove the water and disposal system and have the condenser and water tank located above a water-fill level for the flooded lead-acid batteries 102. The remote maintenance system 100 would then use gravity to fill the flooded lead-acid batteries 102. The valves 107 would control the quantity and pressure of the water added, as the valves 107 could be selected as close when full. In other embodiments, the pump may be replaced with a pressure-reducing valve or a water pressure regulator. Although this configuration reduces the cost and complexity of the system, the filter may require periodic cleaning or replacement, increasing the number of visits an operator may need to make to service the remote maintenance system 100.

The centralized management system 112 can be a cloud-based system. The controller 106 will be connected to it by a network, for example, by radio uplink device, as described herein. When multiple battery installations are set up in different locations, the operator can manage and monitor the different systems remotely. In this embodiment, each individual system has controller 106 that can do the management and monitoring for the site. For use in local configuration, update, and monitoring, the controller 106 can have a data port, such as a USB-C port, and may have a WiFi access point.

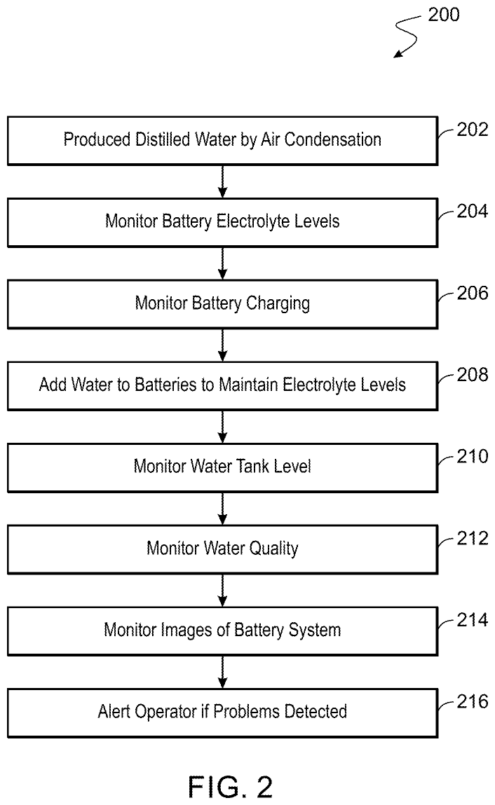

FIG. 2 is a method 200 of remotely maintaining flooded lead acid-batteries using a remote maintenance system. The method begins at block 202 with the production of distilled water by air condensation. The relative humidity of the air may be monitored, and the condenser can be used when the relative humidity is high enough for operation, for example, based on the temperature of the fluid used for the condensation. Accordingly, excess water can be produced and stored during periods of high relative humidity. The water from the air condenser is passed through a water filter to remove any impurities. As described herein, the water filter can include a blockage sensor to determine when the flow through the water filter has decreased, for example, due to plugging from impurities.

At block 204, the electrolyte level in the flooded lead-acid batteries are monitored. For example, level sensors in the flooded lead-acid batteries are used to determine the level of the electrolyte.

At block 206, the charging cycle of the flooded lead-acid batteries are monitored. During charging, gas is formed in the flooded lead-acid batteries, and is released to the atmosphere. Accordingly, the level of the electrolyte in the flooded lead-acid batteries decreases during charging. Thus, monitoring the charging cycle may indicate when a battery will need to have water added, and provides a secondary measurement to the level sensors.

At block 208, water is added to flooded lead-acid batteries as needed to maintain electrolyte levels. This may be performed, for example, by activating a pump on a water line to provide water from a water tank to a battery when the level of the electrolyte drops to a target level specified by the manufacturer. The electrolyte level in the battery is monitored during the addition, and the pump is shut off when the battery reaches a target level.

At block 210, the water level in the water tank is monitored. If the water level drops too low, for example, to less than about 20%, an alert may be sent to an operator. If the water tank is above a target level, for example, greater than about 80%, about 90%, or higher, the controller may turn off the cooler for the air condenser, open a dump valve, or reverse the pump and pump water from the water tank to backwash the filter through a disposal valve.

Backwashing of the filter can be configured by a user configuration. In some embodiments, a backwash will be performed if the water tank is full and the filter cleaning was not done in the last two weeks. During the backwash, 5%-20% of the water tank can be used to clean the water filter by pumping the water through the water filter in reverse, then discarding the water through the disposal valve.

While the system can be used in any number of installations, it is particularly useful in unmanned locations, such as unmanned offshore sites, as flooded lead-acid batteries in these installations have a much higher failure rate. The higher failure rate is mainly due to sulfation caused by the intermittent addition of water to the flooded lead-acid batteries.

At block 212, the water quality in the lines to the battery is monitored. If the water quality indicates a problem, such as a low pH, high particulates, high total dissolved solids, and the like, a valve is shut to the battery and an operator is alerted.

At block 214, images of the battery system are monitored, for example, by a AI visual analysis system. If problems are identified in the images, such as cracking, corrosion, or sulfation, among others, an operator is alerted. The images may then be transferred to the operator automatically or upon demand.

At block 216, an operator is alerted if other problems are detected, such as failure to charge, fire, high gas concentrations in the battery room, and the like. This may be used with the image analysis system to give an operator and image of the battery system when the problems are detected.

FIG. 3 is a block diagram of a control system 300 for the remote maintenance system 100. Like numbered items are as described with respect to FIG. 1. The control system 300 includes the controller 106, sensors/actuators 302, a local control interface 306, and the centralized management system 112. In some embodiments, the controller 106 is a microcontroller, for example, mounted in an enclosure with a battery monitoring and charging system. In other embodiments, the controller 106 is a virtual controller running on a processor in a DCS, on a virtual processor in a cloud server, or using other real or virtual processors.

The controller 106 includes a processor 308. The processor 308 may be a microprocessor, a multi-core processor, a multithreaded processor, an ultra-low-voltage processor, an embedded processor, or a virtual processor. In some embodiments, the processor 308 may be part of a system-on-a-chip (SoC) in which the processor 308 and the other components of the controller 106 are formed into a single integrated electronics package. In various embodiments, the processor 308 may include processors from Intel® Corporation of Santa Clara, California, from Advanced Micro Devices, Inc. (AMD) of Sunnyvale, California, or from ARM Holdings, LTD., Of Cambridge, England. Any number of other processors from other suppliers may also be used.

The processor 308 may communicate with other components of the controller 106 over a bus 310. The bus 310 may include any number of technologies, such as industry standard architecture (ISA), extended ISA (EISA), peripheral component interconnect (PCI), peripheral component interconnect extended (PCIx), PCI express (PCIe), or any number of other technologies. The bus 310 may be a proprietary bus, for example, used in an SoC based system. Other bus technologies may be used, in addition to, or instead of, the technologies above.

The bus 310 may couple the processor 308 to a memory 312. In some embodiments, such as in PLCs and other process control units, the memory 312 is integrated with a data store 314 used for long-term storage of programs and data. The memory 312 include any number of volatile and nonvolatile memory devices, such as volatile random-access memory (RAM), static random-access memory (SRAM), flash memory, and the like. In smaller devices, such as PLCs, the memory 312 may include registers associated with the processor itself. The data store 314 is used for the persistent storage of information, such as data, applications, operating systems, and so forth. The data store 314 may be a nonvolatile RAM, a solid-state disk drive, or a flash drive, among others. In some embodiments, the data store 314 will include a hard disk drive, such as a micro hard disk drive, a regular hard disk drive, or an array of hard disk drives, for example, associated with a DCS or a cloud server.

The bus 310 couples the processor 308 to a sensor interface 316. The sensor interface 316 connects the controller 106 to the sensors used to monitor the electrolysis. In some embodiments, the sensor interface 316 is a bank of analog-to-digital converters (ADCs), an I2C bus, a serial peripheral interface (SPI) bus, or a Fieldbus®, or any combinations thereof.

As described herein, the sensors may include level sensors 104 to determine the electrolyte levels in each of a number of flooded lead-acid batteries. The level sensors 104 can be optical sensors, float sensors, ultrasonic sensors, and the like. In an embodiment, the level sensor is the ELS2—Electrolyte level sensor module available from Vertiv™ of Westerville, OH, USA, for example, as product part number 1008-251. As the installations are likely to be remote, optical sensors may provide the highest reliability. The water quality sensors 110 may include oxidation-reduction potential (ORP) or pH sensors to determine pH and ionic concentration, particulate sensors, organic sensors, and the like. The gas sensors 130 may include hydrogen sensors, acid gas sensors, and the like. In some embodiments, the hydrogen sensor is the NTM SenseH2® hydrogen sensor. The gas sensors 130 can include general environmental sensors, such as an air quality sensor to measure the relative humidity, CO₂ concentration, and ambient temperature. In an embodiment, this sensor is the LGS/A1.2 available from the ABB Group of Stockholm, Sweden.

The level sensor 128 for the water tank can be a flotation device, optical sensors, or an ultrasonic sensor, among others. Commonly available commercial units can be used for the access controls 134, such as the door sensors and door locks, among others. The camera 124 can be a USB camera, or another type of digital camera, link to the controller 106.

The bus 310 couples the processor 308 to a control interface 326 that is used to couple the controller 106 to controls used to the remote maintenance system. In some embodiments, the controller interface 326 is a bank of relays, a bank of MOSFET power controllers, a serial peripheral interface (SPI), or a Fieldbus, and the like. In some embodiments, the controls include the pump 108, which may have three controls, such as an activation switch to turn the pump on or off, a pump speed control, and a prompt direction control. These controls may be included in a single pump unit, for example, using a stepper motor to control speed and direction together. In some embodiments, the valves 107 are solenoid operated valves that are electrically coupled to the controller 106. In other embodiments, the valves 107 are not part of the control system, but are passive units that close when the liquid reaches the valves 107, for example, using an internal float. The exhaust fan actuator 132 may have an associated on off switch and speed control.

The bus 310 couples the processor 308 to a network interface controller (NIC) 332. The NIC 332 couples the controller 106 to the centralized management system 112, for example, through a fiber optic interface, a radio uplink, a satellite uplink, and the like. The NIC 332 may also be used to couple the controller 106 to a local control interface 306. The local control interface 306 can include a display device, such as a screen, and an input device, such as a keyboard, or touch sensitive overlay over the screen.

The data store 314 includes blocks of stored instructions that, when executed, direct the processor 308 to implement the functions of the controller 106. The data store 314 includes a block of instructions, termed a charge monitor 334, to direct the processor 308 to monitor the charging cycle of the flooded lead-acid batteries. This may be performed by communications from a battery monitoring and charging system, for example, through the NIC 332.

The data store 314 includes a block of instructions, termed a battery level monitor 336, to direct the processor 308 to monitor the levels in the flooded lead-acid batteries. For example, the processor may determine the levels from the data provided by the level sensors 104. In some embodiments, the level sensors 104 are continuously providing data, allowing the timeframe for the data collection to be decreased during critical periods, such as charging.

The data store 314 also includes a block of instructions, termed a camera monitor 338, to direct the processor 308 to monitor the images from the camera. As described herein, an image analysis system may be implemented in the controller 106 to perform the analysis. In some embodiments, a commercial image analysis system may be coupled between the controller 106 and the camera 124 to perform the analysis. In these embodiments, an image may not be provided to the controller 106 until the image analysis system detects a critical event, such as the corrosion of a flooded lead-acid battery, or a fire, among others. At that point, the image analysis system may provide images from the camera 124 to the controller 106 to be sent to the centralized management system 112.

The data store 314 includes a block of instructions, termed a system controller 340, to direct the processor 308 to monitor and control the general operation of the system. The system controller 340 works with the sensors/actuators 302, such as the relative humidity sensor, the blockage sensor on the water filter, and the access sensors, among others. For example, the system controller 340 may direct the processor to determine the relative humidity and activate the condenser. Further, the system controller 340 may monitor the blockage sensor to determine if the filter is becoming plugged, and control the backwash of the filter from the water tank. Further, the system controller 340 may direct the processor to detect entry into a battery room, or lock the door to prevent entry during an unsafe condition, such as high acid gas levels.

The data store 314 includes a block of instructions, termed an environmental monitor 342, to direct the processor 308 to monitor and control the environment of the battery room. For example, the environmental monitor 342 may direct the processor to determine levels of hydrogen, acid gases, or both in the battery room. If the gas concentrations are above a preset level, the door locks may be engaged to prevent entry. Further, the environmental monitor 342 can direct the processor to activate the exhaust fan actuator 132, or increase the speed of the exhaust fan through the exhaust fan actuator 132, as needed based on the gas concentrations. Further, the environmental monitor 342 may interface with the HVAC system to control the temperature in the battery room.

The data store 314 includes a block of instructions, termed a fill controller 344, to direct the processor 308 to fill the flooded lead-acid batteries as needed. The fill controller 344 can be activated by the battery level monitor 336. During the filling process, the level sensors 104 are monitored to determine when the filling should be halted.

The data store 314 includes a block of instructions, termed a system communicator 346, to communicate with the centralized management system 112. The communications can include any alarms or alerts from other systems, for example, from the camera monitor, the charge monitor, the system control, or the environmental monitor. The system communicator 346 can accept instructions from the centralized management system 112 for settings and control, including, for example, instructing the controller 106 to forward images from the camera 124. Further, the system communicator 346 can be used with the local control interface 306 to allow programming, and changes to settings, to be made locally.

### EMBODIMENTS

Embodiments described herein provide a system for maintaining a flooded lead-acid battery. The system includes a flooded lead-acid battery, a condenser to condense water from humid air, and a water tank to store the condensed water. A water pump is fluidically coupled between the water tank and the flooded lead-acid battery through a water line, wherein, when activated, the water pump fills the flooded lead-acid battery from the water tank through the water line. The flooded lead-acid battery includes a level sensor to measure the level of electrolyte in the flooded lead-acid battery and a controller, wherein the controller is coupled to the level sensor and the water pump. The controller includes a processor and instructions that direct the processor to monitor the level of electrolyte in the flooded lead-acid battery and activate the water pump if the level of electrolyte is lower than a target value.

In an embodiment, combinable with any other embodiment, the system includes a water filter fluidically coupled between the condenser and the water tank.

In an embodiment, combinable with any other embodiment, the system includes a blockage sensor on the water filter electrically coupled to the controller. The controller includes instructions that direct the processor to monitor the blockage sensor and alert an operator if flow through the water filter is below a target value.

In an embodiment, combinable with any other embodiment, the system includes a back flush valve fluidically coupled to a line between the condenser and the water filter, wherein the back flush valve is electrically coupled to the controller. The controller includes instructions to direct the processor to open the back flush valve, reverse the water pump, and activate the water pump to backwash the filter.

In an embodiment, combinable with any other embodiment, the system includes a valve fluidically coupled between the flooded lead-acid battery and the water line, wherein the valve prevents backflow from the flooded lead-acid battery into the water line.

In an embodiment, combinable with any other embodiment, the system includes a water quality sensor electrically coupled to the controller.

In an embodiment, combinable with any other embodiment, the system includes a water cutoff valve on the water line, wherein the water cutoff valve is electrically coupled to the controller.

In an embodiment, combinable with any other embodiment, the controller includes instructions that direct the processor to close the water cutoff valve if the water quality sensor detects a low pH, high impurity levels, or high particulate concentrations, or any combinations thereof.

In an embodiment, combinable with any other embodiment, the system includes a camera electrically coupled to the controller, wherein the controller includes image analysis software.

In an embodiment, combinable with any other embodiment, the image analysis software includes an artificial intelligence (AI) analysis to determine if an image indicates problems with the flooded lead-acid battery.

In an embodiment, combinable with any other embodiment, the system includes a gas analysis sensor electrically coupled to the controller.

In an embodiment, combinable with any other embodiment, the system includes the gas analysis sensor includes a hydrogen sensor, an acid gas sensor, or both.

In an embodiment, combinable with any other embodiment, the system includes an exhaust fan actuator electrically coupled to the controller.

In an embodiment, combinable with any other embodiment, the controller includes instructions to direct the processor to activate the exhaust fan if hydrogen gas, acid gas, or both are detected.

In an embodiment, combinable with any other embodiment, the system includes a door lock switch, and entry detector, or both, wherein the controller includes instructions to direct the processor to lock a door in response to an alarm condition.

In an embodiment, combinable with any other embodiment, the controller includes a communications unit coupled to a centralized management and control system.

In an embodiment, combinable with any other embodiment, the system includes a radio uplink coupled to the communications unit, wherein the radio uplink is coupled to the centralized management and control system.

Another embodiment described herein provides a method of automatically maintaining a flooded lead-acid battery. The method includes producing distilled water from air condensation, monitoring an electrolyte level in the flooded lead-acid battery, and adding the distilled water to the flooded lead-acid battery to maintain the electrolyte level.

In an embodiment, combinable with any other embodiment, the method includes monitoring a charging cycle of the flooded lead-acid battery, and adding the distilled water based on the charging cycle.

In an embodiment, combinable with any other embodiment, the method includes monitoring a relative humidity of the air, producing the distilled water from the air condensation when the relative humidity is high. The distilled water is stored in a water tank.

In an embodiment, combinable with any other embodiment, the method includes monitoring a level in the water tank and alerting an operator if the level drops below a predetermined level.

In an embodiment, combinable with any other embodiment, the method includes monitoring quality of the distilled water.

In an embodiment, combinable with any other embodiment, the method includes closing a shut off valve if the pH of the distilled water is too low.

Other implementations are also within the scope of the following claims.

What is claimed is:

1. A system for maintaining a flooded lead-acid battery, comprising:
a flooded lead-acid battery;
a condenser to condense water from humid air;
a water tank to store the condensed water;
a water pump fluidically coupled between the water tank and the flooded lead-acid battery through a water line, wherein, when activated, the water pump fills the flooded lead-acid battery from the water tank through the water line;
a level sensor on the flooded lead-acid battery to measure the level of electrolyte in the flooded lead-acid battery;
a controller, wherein the controller is coupled to the level sensor and the water pump, and wherein the controller comprises:
a processor; and
instructions that direct the processor to:
monitor the level of electrolyte in the flooded lead-acid battery; and
activate the water pump if the level of electrolyte is lower than a target value.

2. The system of claim 1, comprising a water filter fluidically coupled between the condenser and the water tank.

3. The system of claim 2, comprising:
a blockage sensor on the water filter electrically coupled to the controller; and
instructions that direct the processor to:
monitor the blockage sensor; and
alert an operator if flow through the water filter is below a target value.

4. The system of claim 2, comprising a back flush valve fluidically coupled to a line between the condenser and the water filter, wherein the back flush valve is electrically coupled to the controller, and wherein the controller comprises instructions to direct the processor to:
open the back flush valve;
reverse the water pump; and
activate the water pump to backwash the filter.

5. The system of claim 1, comprising a valve fluidically coupled between the flooded lead-acid battery and the water line, wherein the valve prevents backflow from the flooded lead-acid battery into the water line.

6. The system of claim 1, comprising a water quality sensor electrically coupled to the controller.

7. The system of claim 6, comprising a water cutoff valve on the water line, wherein the water cutoff valve is electrically coupled to the controller.

8. The system of claim 7, wherein the controller comprises instructions that direct the processor to close the water cutoff valve if the water quality sensor detects a low pH, high impurity levels, or high particulate concentrations, or any combinations thereof.

9. The system of claim 1, comprising a camera electrically coupled to the controller, wherein the controller comprises image analysis software.

10. The system of claim 9, wherein the image analysis software comprises an artificial intelligence (AI) analysis to determine if an image indicates problems with the flooded lead-acid battery.

11. The system of claim 1, comprising a gas analysis sensor electrically coupled to the controller.

12. The system of claim 11, wherein the gas analysis sensor comprises a hydrogen sensor, an acid gas sensor, or both.

13. The system of claim 1, comprising an exhaust fan actuator electrically coupled to the controller.

14. The system of claim 13, wherein the controller comprises instructions to direct the processor to activate the exhaust fan if hydrogen gas, acid gas, or both are detected.

15. The system of claim 1, comprising a door lock switch, and entry detector, or both, wherein the controller comprises instructions to direct the processor to lock a door in response to an alarm condition.

16. The system of claim 1, wherein the controller comprises a communications unit coupled to a centralized management and control system.

17. The system of claim 16, comprising a radio uplink coupled to the communications unit, wherein the radio uplink is coupled to the centralized management and control system.

18. A method of automatically maintaining a flooded lead-acid battery, comprising:
producing distilled water from air condensation;
monitoring an electrolyte level in the flooded lead-acid battery; and
adding the distilled water to the flooded lead-acid battery to maintain the electrolyte level.

19. The method of claim 18, comprising monitoring a charging cycle of the flooded lead-acid battery, and adding the distilled water based on the charging cycle.

20. The method of claim 18, comprising:
monitoring a relative humidity of the air;
producing the distilled water from the air condensation when the relative humidity is high; and
storing the distilled water in a water tank.

21. The method of claim 20, comprising:
monitoring a level in the water tank; and
alerting an operator if the level drops below a predetermined level.

22. The method of claim 18, comprising monitoring quality of the distilled water.

23. The method of claim 22, comprising closing a shut off valve if the pH of the distilled water is too low.
